(19) United States
(12) Patent Application Publication
(10) Pub. No.: US 2025/0023250 A1
(43) Pub. Date: Jan. 16, 2025

(54) RECEPTION APPARATUS AND COMMUNICATION SYSTEM

(71) Applicant: CANON KABUSHIKI KAISHA, Tokyo (JP)

(72) Inventor: YUKI SHOJI, Kanagawa (JP)

(21) Appl. No.: 18/770,035

(22) Filed: Jul. 11, 2024

(30) Foreign Application Priority Data
Jul. 13, 2023 (JP) 2023-115400

(51) Int. Cl. H01Q 13/20; H04L 25/02

(52) U.S. Cl. CPC H01Q 13/206; H04L 25/0272

(57) ABSTRACT

A reception apparatus includes a plurality of reception electrodes arranged at positions opposing one transmission line of a transmission apparatus, and a connection path configured to connect the plurality of reception electrodes, wherein the connection path includes at least one passive element between the reception electrodes.

### BACKGROUND

### Field

The present disclosure relates to a reception apparatus and a communication system.

### Description of the Related Art

In recent years, there has been an increasing number of communication systems in which communication apparatuses, such as cameras, handling a large amount of data are attached to production systems, robot apparatuses, or the like, and data transmission is performed at a high speed between mechanical moving parts and fixed parts. Japanese Patent No. 6304906 discusses a wireless communication system that performs data transmission in a noncontact manner, using an electromagnetic near field between an annular differential line that is a transmission line of a transmission apparatus and a near-field probe of a reception apparatus.

### SUMMARY

According to some embodiments, a reception apparatus includes a plurality of reception electrodes arranged at positions opposing one transmission line of a transmission apparatus, and a connection path configured to connect the plurality of reception electrodes, wherein the connection path includes at least one passive element between the reception electrodes. According to some embodiments, a communication system includes the reception apparatus described above, and the transmission apparatus.

Further features of the present disclosure will become apparent from the following description of exemplary embodiments with reference to the attached drawings.

### BRIEF DESCRIPTION OF THE DRAWINGS

FIGS. 1A and 1B are diagrams for describing an overview of a configuration of a communication system according to an exemplary embodiment of the present disclosure.

FIGS. 2A, 2B, 2C, 2D, and 2E are timing charts of signals at respective component parts of the communication system illustrated in FIG. 1A.

FIG. 3 is a diagram illustrating an example of an overview of a configuration of a communication system according to a comparative example.

FIG. 4 is a diagram qualitatively illustrating a relationship between the length of reception electrodes and the performance of a reception apparatus in the communication system according to the comparative example illustrated in FIG. 3.

FIG. 5 is a diagram illustrating a first example of the overview of the configuration of the communication system according to the exemplary embodiment of the present disclosure.

FIG. 6 is a diagram qualitatively illustrating a relationship between the total length of reception electrodes and the performance of a reception apparatus in the communication system according to the exemplary embodiment of the present disclosure illustrated in FIG. 5.

FIGS. 7A, 7B, and 7C are diagrams illustrating results of analysis of the performance of the reception apparatus, by an electromagnetic field simulator, in the communication system according to the comparative example illustrated in FIG. 3.

FIGS. 8A, 8B, and 8C are diagrams illustrating results of analysis of the performance of the reception apparatus, by the electromagnetic field simulator, in the communication system according to the exemplary embodiment of the present disclosure illustrated in FIG. 5.

FIG. 9 is a diagram illustrating a second example of the overview of the configuration of the communication system according to the exemplary embodiment of the present disclosure.

### DESCRIPTION OF THE EMBODIMENTS

Hereinafter, various exemplary embodiments, features, and aspects of the present disclosure will be described with reference to the drawings.

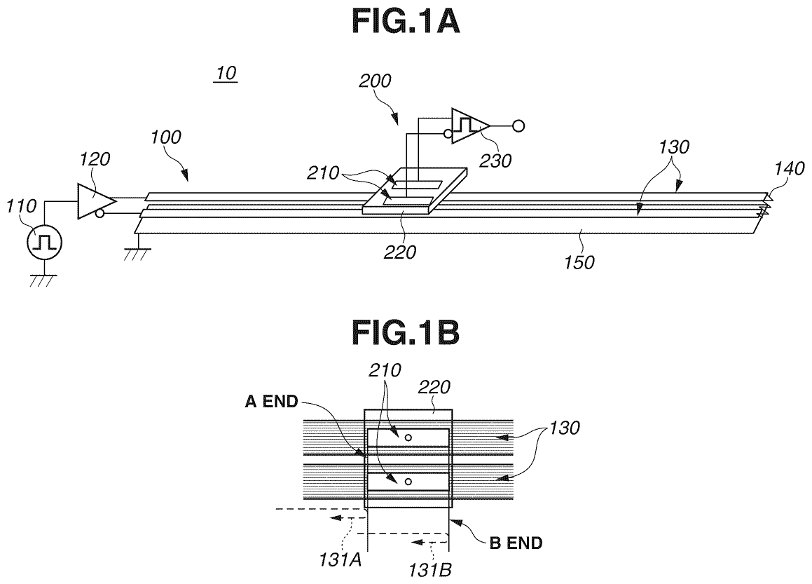

FIGS. 1A and 1B are diagrams for describing an overview of a configuration of a communication system 10 according to the exemplary embodiment of the present disclosure. The communication system 10 is a wireless communication system in which a transmission apparatus 100 and a reception apparatus 200 wirelessly communicate with each other.

The transmission apparatus 100 includes a signal source 110, a transmission circuit 120, transmission lines 130, a termination resistor 140, and a reference potential surface (ground surface) 150.

The signal source 110 outputs data signals. More specifically, the signal source 110 is an input signal source of the transmission circuit 120. The transmission circuit 120 amplifies the data signals from the signal source 110, and outputs the data signals to the transmission lines 130. The transmission lines 130 are configured as differential lines that are differential microstrip lines formed on the reference potential surface 150 in the example illustrated in FIG. 1A. In the present disclosure, the transmission lines 130 are not limited to the differential lines and may be another type of transmission line (for example, a single transmission line). The termination resistor 140 is a resistor that is arranged at an end of the transmission lines 130 and is substantially equal to characteristic impedance of the transmission lines 130 (differential lines). The reference potential surface 150 is a ground surface having the reference potential for the transmission lines 130, and is generally formed on a surface of a substrate (not illustrated) opposite to a surface on which the transmission lines 130 are formed.

The reception apparatus 200 includes reception electrodes 210, a substrate 220, and a reception circuit 230. The reception apparatus 200 relatively moves above and along the transmission lines 130 while keeping a constant distance from the transmission lines 130. The movement is performed, for example, by a movement control unit (not illustrated), such as a motor (for example, a movement control unit that moves the reception apparatus 200 with respect to the transmission lines 130).

The reception electrodes 210 are electrodes of the reception apparatus 200 that are arranged at positions opposing the respective transmission lines 130 of the transmission apparatus 100. The reception electrodes 210 are formed on the substrate 220, and move along the transmission lines 130 in a space above the transmission lines 130 while keeping a constant distance from the transmission lines 130. In the example illustrated in FIGS. 1A and 1B, detailed configurations of the reception electrodes 210 are not illustrated. In the present disclosure, the reception electrodes 210 may also be referred to as reception couplers. The substrate 220 is a dielectric substrate on which the reception electrodes 210 are provided. The reception circuit 230 processes signals detected by the reception electrodes 210 to generate output signals.

The reception electrodes 210 of the reception apparatus 200 perform wireless communication by being coupled to the transmission lines 130 of the transmission apparatus 100 via an electric field, a magnetic field, or both (electromagnetic coupling), and detect the signals transmitted through the transmission lines 130. The signals detected by the reception electrodes 210 are wave-shaped by the reception circuit 230 and generated as received signals.

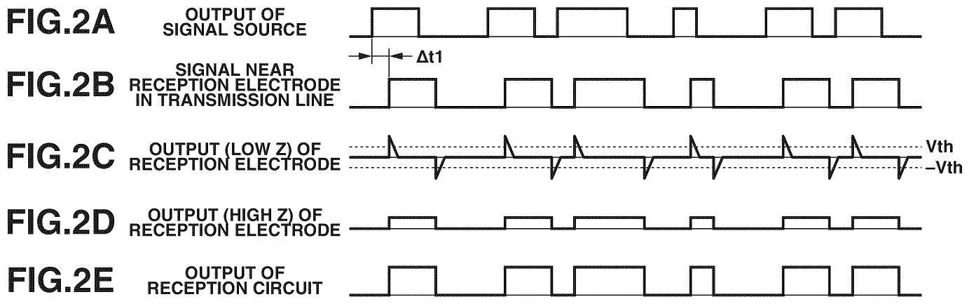

FIGS. 2A to 2E are timing charts of signals at respective component parts of the communication system 10 illustrated in FIG. 1A. Specifically, FIG. 2A illustrates an example of an output signal of the signal source 110. FIG. 2B illustrates an example of a signal of a transmission line 130 near a reception electrode 210. FIG. 2C illustrates an example of an output signal of the reception electrode 210 in a case where input impedance of the reception circuit 230 is low. FIG. 2D illustrates an example of an output signal of the reception electrode 210 in a case where the input impedance of the reception circuit 230 is high. FIG. 2E illustrates an example of an output signal of the reception circuit 230.

In the case where the input impedance of the reception circuit 230 is low, the output of the reception electrode 210 is an edge signal as illustrated in FIG. 2C, and as illustrated in FIG. 2E, a wave-shaping circuit, such as a comparator having a ±Vth hysteresis voltage, performs wave-shaping on the output and demodulates the output. On the other hand, in the case where the input impedance of the reception circuit 230 is high, the output of the reception electrode 210 has a waveform with a small amplitude similar to the input waveform, as illustrated in FIG. 2D. Thus, the reception circuit 230 may be an amplifier, for example, that amplifies a signal to a magnitude at which digital signal processing is possible.

When the reception electrodes 210 move above (with a distance from) the transmission lines 130, the impedance of the transmission lines 130 becomes disturbed under the influence of the reception electrodes 210. In order to increase the intensity of signals transferred from the transmission lines 130 to the reception electrodes 210, the distance between the transmission lines 130 and the reception electrodes 210 may be reduced. However, as they come closer to each other, disturbance of the impedance described above becomes larger. When the disturbance of the impedance is large, the input characteristics of the transmission lines 130 become deteriorated. Even if an attempt is made to input a normal signal from the transmission circuit 120, frequency components with large reflection are less likely to be input, whereby the waveform of the input signal becomes distorted. With reference to FIG. 1B, a principle of a signal transmitted through the transmission lines 130 being disturbed by the reception electrodes 210 will be described.

The transmission lines 130 illustrated in FIG. 1B have free spaces above parts of the transmission lines 130 where the reception electrodes 210 are not located. At an end A of the reception electrodes 210, the space above the transmission lines 130 is blocked by electrodes of the reception electrodes 210 or a dielectric body constituting the substrate 220, so that signals input from input terminals of the transmission lines 130 are reflected due to a change in a transmission mode. At an end B of the reception electrodes 210, the space above the transmission lines 130 is changed from a blocked state to the free space, so that signals are reflected due to a change in the transmission mode as in the case of the end A. In FIG. 1B, a reflection wave 131A is a reflection wave of a signal having been transmitted through the transmission line 130 and reflected at the end A of the reception electrodes 210, and a reflection wave 131B is a reflection wave of a signal having been transmitted through the transmission line 130 and reflected at the end B of the reception electrodes 210. As above, if a signal having been transmitted through the transmission line 130 is greatly reflected, the reflection affects the input characteristics. It also affects the output characteristics of the reception electrodes 210, and the gain decreases in a frequency band with great reflection in the input characteristics, and thus a correct signal cannot be received, which may cause a reception error. The intensity of the above-described reflection tends to become higher with an increase in length and area of the reception electrodes 210. In order to increase the intensity of the signal received by the reception electrodes 210, the length and area of the reception electrodes 210 may be increased. However, there is a relationship of tradeoff between the increase in the intensity of the signal received by the reception electrodes 210 and the suppression of the intensity of the reflection described above.

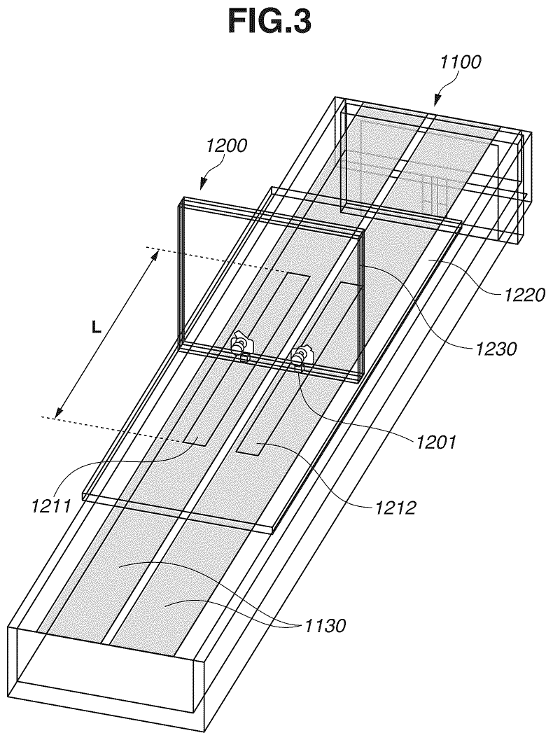

FIG. 3 is a diagram illustrating an example of an overview of a configuration of a communication system 1010 according to a comparative example. A transmission apparatus 1100 illustrated in FIG. 3 includes transmission lines 1130 corresponding to the transmission lines 130 illustrated in FIGS. 1A and 1B, and may also include component parts corresponding to the signal source 110, the transmission circuit 120, the termination resistor 140, and the reference potential surface 150 illustrated in FIG. 1A. A reception apparatus 1200 illustrated in FIG. 3 includes reception electrodes 1211 and 1212 corresponding to the reception electrodes 210 illustrated in FIGS. 1A and 1B, a substrate 1220 corresponding to the substrate 220 illustrated in FIGS. 1A and 1B, and a reception circuit 1230 corresponding to the reception circuit 230 illustrated in FIG. 1A. Positions 1201 illustrated in FIG. 3 are each an approximate central position of each of the reception electrodes 1211 and 1212, and are positions of connection points to the reception circuit 1230. The reception electrodes 1211 and 1212 are arranged to oppose the corresponding transmission lines 1130.

The differential lines that are applied as the transmission lines 1130 transmit high-frequency differential signals. The reception circuit 1230 generates a received signal that is a potential difference excited between the reception electrodes 1211 and 1212 by the high-frequency differential signals transmitted through the transmission lines 1130. FIG. 3 illustrates a length L in a longitudinal direction of the reception electrodes 1211 and 1212. The length L is a key parameter that defines performance of the reception apparatus 1200. Hereinafter, the performance of the reception apparatus 1200 will be described in detail. The performance of the reception apparatus 1200 can be roughly classified into three items described below.
[1] The degree of influence on the transmission lines
[2] The received signal intensity in a high-frequency band
[3] The received signal intensity in a low-frequency band

First, “[1] the degree of influence on the transmission lines” can also be referred to as the degree of disturbance caused to high-frequency signals transmitted through the transmission lines due to the presence of the reception electrodes.

In other words, as the degree of influence on the transmission lines is smaller, there is a higher possibility that the performance of the reception electrodes is excellent. With an increase in the length L, a length over which the transmission lines and the reception electrodes run parallel increases, and the degree of influence on the transmission lines tends to increase.

Next, with regard to “[2] the received signal intensity in a high-frequency band”, an increase in the intensity of a received signal in a high-frequency band means that signals can be transmitted at a higher data rate. In other words, as the intensity of a received signal in a high-frequency band is higher, the performance of the reception electrode is more excellent.

Along with an increase in the length L, a self-resonant frequency of each of the reception electrodes 1211 and 1212 decreases. At a frequency higher than or equal to the self-resonant frequency, the reception electrodes 1211 and 1212 perform inductive operations (operate as inductors). More specifically, as the frequency increases, the impedances of the reception electrodes 1211 and 1212 increase, and as a result, the intensity of a received signal decreases. Thus, the length L of the reception electrodes 1211 and 1212 is limited to a length at which the self-resonant frequency of each of the reception electrodes 1211 and 1212 is such that the reception electrodes 1211 and 1212 can transmit signals at a desired data rate.

For example, if the desired data rate is 10 giga bit per second (Gbps), it is desired that the self-resonant frequency of each of the reception electrodes 1211 and 1212 is sufficiently higher than 5 gigahertz (GHz) that is the dominant frequency of a signal. A specific length is calculated on an assumption that the reception electrodes 1211 and 1212 are formed on a flame retardant type 4 (FR4) substrate (with a relative dielectric constant of 4.3). As a condition for occurrence of self-resonance, it is assumed that a standing wave occurs at a target frequency with the maximum voltage at end portions with respect to the longitudinal direction of the reception electrode 1211 or 1212. At this time, the length L at which the self-resonance occurs at 5 GHz is about 14.5 mm (millimeters). Therefore, in order to enable signal transmission by the reception apparatus 1200 illustrated in FIG. 3 at the data rate of 10 Gbps, the length L of the reception electrodes 1211 and 1212 is desirably 14.5 mm or less.

With regard to “[3] the received signal intensity in a low-frequency band”, an increase in the intensity of a received signal in a low-frequency band means that a signal closer to a direct current (0 Hz) can be transmitted.

More specifically, since an average voltage (direct-current component) of a received signal can be wirelessly transmitted with accuracy, an effect of reducing jitter (fluctuation) generated near zero crossing of the signal is expected. Accordingly, as the intensity of a received signal in a low-frequency band is higher, the performance of the reception electrode is more excellent. Conditions for increasing the intensity of a received signal in a low-frequency band will be considered. According to the above-described example, the low-frequency band is defined as a frequency band of 500 megahertz (MHz) or less for signal transmission at a data rate of 10 Gbps. In other words, the low-frequency band is a frequency band that is one-tenth of 5 GHz that is the dominant frequency of a signal. The electrical length in the free space of 500 MHz is about 600 mm. Therefore, if the length L of the reception electrodes 1211 and 1212 is sufficiently short (small) relative to 600 mm, the reception electrodes 1211 and 1212 can be treated as lumped constants. In other words, the reception electrodes 1211 and 1212 can be treated as capacitors that are electrostatically coupled to the transmission lines 1130. In order to increase the intensity of a received signal in the low-frequency band under this condition, it is obvious that the areas of the reception electrodes 1211 and 1212 should be increased in consideration of the general nature of capacitors. In other words, the length L of the reception electrodes 1211 and 1212 may be increased.

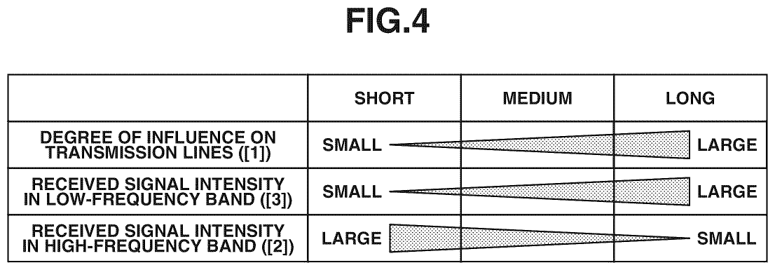

FIG. 4 is a diagram qualitatively illustrating a relationship between the length L of the reception electrodes 1211 and 1212 and the performance of the reception apparatus 1200 in the communication system 1010 according to the comparative example illustrated in FIG. 3. Specifically, FIG. 4 illustrates the length L of the reception electrodes 1211 and 1212 in a horizontal direction, and illustrates the performance of the reception apparatus 1200 in a vertical direction.

As can be seen in FIG. 4, there is a tradeoff relationship between the length L of the reception electrodes 1211 and 1212 and the performance of the reception apparatus 1200. In the case of prioritizing the increase of “[2] the received signal intensity in a high-frequency band”, “[3] the received signal intensity in a low-frequency band” may be sacrificed. The data rate in communication systems has become higher year by year, and there is an increasing demand for wireless transmission at a data rate of 10 Gbps or more. In order to increase the data rate, the length L of the reception electrodes 1211 and 1212 needs to be reduced as described above. This satisfies the need for increasing “[2] the received signal intensity in a high-frequency band”.

On the other hand, “[3] the received signal intensity in a low-frequency band” decreases. In order to improve quality of communication, it is desirable to increase both “[2] the received signal intensity in a high-frequency band” and “[3] the received signal intensity in a low-frequency band”. However, it is difficult to achieve this by the reception apparatus 1200 according to the comparative example illustrated in FIG. 3.

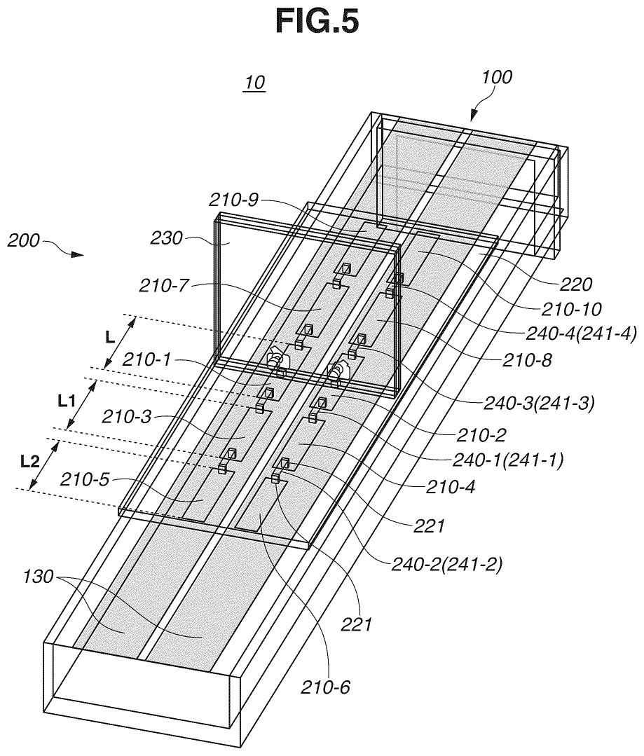

FIG. 5 is a diagram illustrating a first example of the overview of the configuration of the communication system 10 according to the exemplary embodiment of the present disclosure. In FIG. 5, the components similar to those illustrated in FIGS. 1A and 1B are indicated by the same reference signs, and detailed descriptions thereof will be omitted.

The transmission apparatus 100 illustrated in FIG. 5 includes the transmission lines 130, and also includes the signal source 110, the transmission circuit 120, the termination resistor 140, and the reference potential surface 150 illustrated in FIG. 1A.

The reception apparatus 200 illustrated in FIG. 5 includes a plurality of reception electrodes 210-1 to 210-10 corresponding to the reception electrodes 210 illustrated in FIGS. 1A and 1B, the substrate 220, the reception circuit 230, and connection paths 240. In the reception apparatus 200 illustrated in FIG. 5, the plurality of reception electrodes 210-1, 210-3, 210-5, 210-7, and 210-9 is arranged at positions opposing one of two differential lines (a first transmission line) constituting the transmission lines 130. In addition, in the reception apparatus 200 illustrated in FIG. 5, the plurality of reception electrodes 210-2, 210-4, 210-6, 210-8, and 210-10 is arranged at positions opposing the other of the two differential lines (a second transmission line) constituting the transmission lines 130.

In the reception apparatus 200 illustrated in FIG. 5, the reception electrodes 210-1 and 210-2 have the length L in the longitudinal direction and correspond to the reception electrodes 1211 and 1212 illustrated in FIG. 3, for example. In the reception apparatus 200 illustrated in FIG. 5, in addition to the reception electrodes 210-1 and 210-2, the plurality of reception electrodes 210-3 to 210-10 is further formed on the substrate 220 that is a dielectric substrate.

Further, in the reception apparatus 200 illustrated in FIG. 5, the connection paths 240 are arranged to electrically connect the plurality of reception electrodes 210 that are adjacent to each other. Specifically, in FIG. 5, a connection path 240-1 is arranged to connect the adjacent reception electrodes 210-2 and 210-4, and a connection path 240-2 is arranged to connect the adjacent reception electrodes 210-4 and 210-6. In addition, in FIG. 5, a connection path 240-3 is arranged to connect the adjacent reception electrodes 210-2 and 210-8, and a connection path 240-4 is arranged to connect the adjacent reception electrodes 210-8 and 210-10. Although no reference signs are given in FIG. 5, the connection paths 240 are also arranged between the adjacent reception electrodes 210-1 and 210-3, between the adjacent reception electrodes 210-3 and 210-5, the adjacent reception electrodes 210-1 and 210-7, and the adjacent reception electrodes 210-7 and 210-9. The connection paths 240 are arranged at a height different from a height of the reception electrodes 210 with reference to the substrate 220 that is a dielectric substrate. Specifically, the connection paths 240 are arranged above the substrate 220 so as to be higher than the reception electrodes 210. More specifically, in the present exemplary embodiment, the substrate 220 has through-hole vias 221 as illustrated in FIG. 5, and the connection paths 240 connect the adjacent reception electrodes 210 via the through-hole vias 221 formed on the substrate 220.

Each connection path 240 includes at least one passive element 241 in series between the adjacent reception electrodes of the plurality of reception electrodes. Specifically, each connection path 240 is composed of a conductor, and a slit area is formed in a part of the conductor. The at least one passive element 241 described above is arranged in the slit area to electrically connect slit areas. The connection path 240 has the slit area for the reason that mounting of a commercial passive element 241 is assumed, for example. In the present exemplary embodiment, the passive element 241 can be implemented by a substrate pattern (conductor shape). The at least one passive element 241 arranged in the connection path 240 here includes at least one of a resistor, an inductor, and a ferrite bead (two or more of them may be included). Among the resistor, the inductor, and the ferrite bead that may be included as the passive element 241, the use of the resistor is preferred in view of phase characteristics of a received signal at the reception apparatus 200. In the case of applying resistors as passive elements 241, resistance values of the resistors mounted on the connection paths 240 may be different or may be all identical.

Subsequently, the reason why the reception apparatus 200 illustrated in FIG. 5 solves the issue of a tradeoff between the length L of the reception electrodes and the performance of the reception apparatus described above with reference to FIG. 4 will be described below. According to the example described above, the description below is based on an assumption that communication is performed at a date rate of 10 Gbps using the reception apparatus 200 illustrated in FIG. 5.

In FIG. 5, the length L of the reception electrodes 210-1 and 210-2 corresponds to the length L of the reception electrodes 1211 and 1212 illustrated in FIG. 3. As illustrated in FIG. 5, a length L1 is the length of the reception electrodes 210-3 and 210-4, and a length L2 is the length of the reception electrodes 210-5 and 210-6. Here, attention will be focused on the reception electrodes 210-1, 210-3, and 210-5. As described above, the length of the reception electrodes is desirably 14.5 mm or less in order to enable transmission at the data rate of 10 Gbps. Therefore, it is assumed here that the length L, the length L1, and the length L2 are all 14.5 mm or less. More specifically, the self-resonance frequency of each of the reception electrodes 210-1, 210-3, and 210-5 is sufficiently higher than 5 GHz that is the dominant frequency of a signal. In the reception electrodes 210-1, 210-3, and 210-5, if 0 ohms (Ω) is implemented in the connection paths 240 connecting the adjacent reception electrodes, the reception electrodes 210-1, 210-3, and 210-5 are considered to perform operations electrically equivalent to an operation of one electrode. In other words, the reception electrodes 210-1, 210-3, and 210-5 operate as a reception electrode with a length of 14.5 (mm)×3=43.5 (mm) at maximum. With the length of 43.5 (mm), it is not possible to satisfy the condition that the self-resonance frequency of the reception electrodes needs to be sufficiently higher than 5 GHz that is the dominant frequency of a signal, and there is a very high possibility that data transmission at 10 Gbps cannot be achieved. On the other hand, if resistors of 1 megaohm (MΩ) are mounted on the connection paths 240 connecting the adjacent reception electrodes, the reception electrodes 210-1, 210-3, and 210-5 are considered to operate as electrically independent electrodes. In view of the entire reception apparatus 200 according to the present exemplary embodiment, the reception apparatus 200 performs operations substantially equivalent to operations in a mode where only the reception electrodes 210-1 and 210-2 are connected to the reception circuit 230 (although the degree of influence on the transmission lines 130 is different).

It is assumed here that resistors of several tens of Ω to several thousands of Ω are mounted on the connection paths 240-1, 240-2, 240-3, and 240-4 as the passive elements 241-1, 241-2, 241-3, and 241-4. The reception electrodes 210-1, 210-3, and 210-5 are electrically connected with each other while being accompanied by losses according to resistance values of the resistors mounted as the passive elements 241. Even if there occurs self-resonance equivalent to the resonance frequency of a reception electrode with a length of 14.5 (mm)×2=29.0 (mm), electrical energy by the resonance is immediately converted into thermal energy and disappears due to the losses resulting from the resistors mounted on the connection paths 240. This phenomenon exerts the same effect on self-resonance equivalent to the resonance frequency of a reception electrode with a length of 14.5 (mm)×3 =43.5 (mm). The effect can be expected to be higher as the number of resistors mounted on the connection paths 240 has increased. Similarly, the same effect can be expected for the reception apparatus 200 in which n reception electrodes 210 are connected with (n−1) connection paths 240 via resistors with appropriate resistance values. From the viewpoint of electrical circuitry, the effect can be referred to as an effect of reducing the quality factor (Q value) of self-resonance occurring in accordance with the length of the reception electrodes 210, by the resistors mounted on the connection paths 240. With the above-described effect, the reception apparatus 200 according to the present exemplary embodiment can infinitely extend the physical length of the reception electrodes 210 in principle while keeping the self-resonance frequency of the reception electrodes 210 at sufficiently higher levels than 5 GHz that is the dominant frequency of a signal. This suggests that, in a low-frequency band of 500 MHz or less, it is possible to infinitely increase coupling capacitances of the reception electrodes 210 that can be treated as capacitors making electrostatic coupling to the transmission lines 130. In other words, the reception apparatus 200 according to the present exemplary embodiment makes it possible to increase both the received signal intensity in a high-frequency band and the received signal intensity in a low-frequency band, thereby improving the quality of communication.

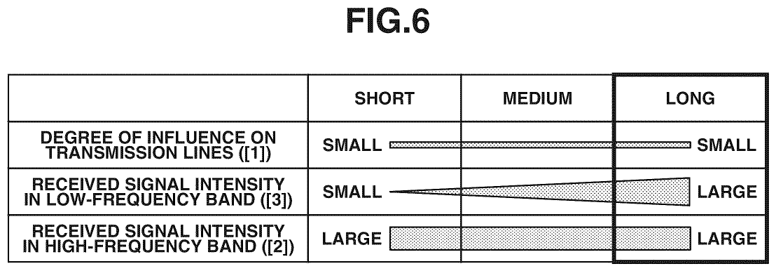

FIG. 6 is a diagram qualitatively illustrating a relationship between the total length of the reception electrodes 210 and the performance of the reception apparatus 200 in the communication system 10 according to the present exemplary embodiment of the present disclosure illustrated in FIG. 5. Specifically, FIG. 6 illustrates the total length of the reception electrodes 210 in the horizontal direction, and illustrates the performance of the reception apparatus 200 in the vertical direction.

As can be seen in FIG. 6, there is established a relationship between the total length of the reception electrodes 210 and the performance of the reception apparatus 200 that the performance of the reception apparatus 200 improves as the total length of the reception electrodes 210 increases. More specifically, along with an increase in the total length of the reception electrodes 210, it is possible to, increase “[3] the received signal intensity in a low-frequency band” while keeping “[2] the received signal intensity in a high-frequency band” at a high level and suppressing “[1] the degree of influence on the transmission lines” to a low level.

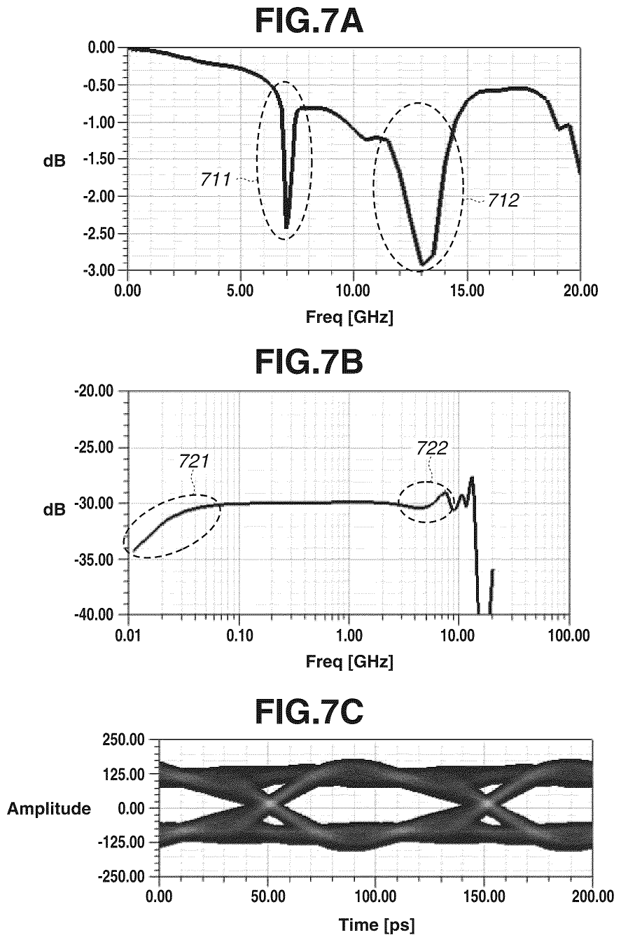

FIGS. 7A to 7C are diagrams illustrating results of analysis of the performance of the reception apparatus 1200, by an electromagnetic field simulator, in the communication system 1010 according to the comparative example illustrated in FIG. 3. The length L of the reception electrodes 1211 and 1212 is set here to 14 mm. The length of the transmission lines 1130 is set to 100 mm. The input impedance of the reception circuit 1230 is set to 10 kiloohms (kΩ).

FIG. 7A is a diagram illustrating an insertion loss (Sdd21) from a power supply part to a terminal end part in a state where the reception apparatus 1200 according to the comparative example illustrated in FIG. 3 is arranged in proximity to the transmission lines 1130. A propagation loss of the transmission lines 1130 is within −1.5 dB (decibels) in a band of 20 GHz or less in a state where the reception apparatus 1200 is not arranged in proximity. In FIG. 7A, a deterioration of the insertion loss in a region 711 indicates that the transmission lines 1130 are under an influence of primary self-resonance of the reception electrodes 1211 and 1212 with L=14 mm. Further, in FIG. 7A, a deterioration of the insertion loss in a region 712 indicates that the transmission lines 1130 are under an influence of secondary self-resonance of the reception electrodes 1211 and 1212. If the length L of the reception electrodes 1211 and 1212 is increased from 14 mm, the frequency bands in which the transmission lines 1130 are influenced by the reception apparatus 1200, which are indicated in the regions 711 and 712, shift to the low-frequency band side.

FIG. 7B is a diagram illustrating an insertion loss (Sdd21) from power supply parts of the transmission lines 1130 to an input part of the reception circuit 1230 according to the comparative example illustrated in FIG. 3. In FIG. 7B, attention will be focused on the received signal intensity in a low-frequency band in a region 721. The received signal intensity in a low-frequency band in the region 721 starts to gradually decrease around 50 MHz and drops by about −5 dB at 10 MHz, with respect to the received signal intensity around 1 GHz (the approximate average of the received signal intensity). In FIG. 7B, a region 722 indicates the received signal intensity around the dominant frequency of 5 GHz (the received signal intensity in a high-frequency band) at an assumed data rate of 10 Gbps. The received signal intensity around the region 722 hardly changes with respect to the received signal intensity around 1 GHz.

FIG. 7C is a diagram illustrating a signal eye pattern observed at the input part of the reception circuit 1230 according to the comparative example illustrated in FIG. 3. The data rate of signal transmission in the transmission lines 1130 is set to 10 Gbps. In this case, the eye opening rate is 83.2%.

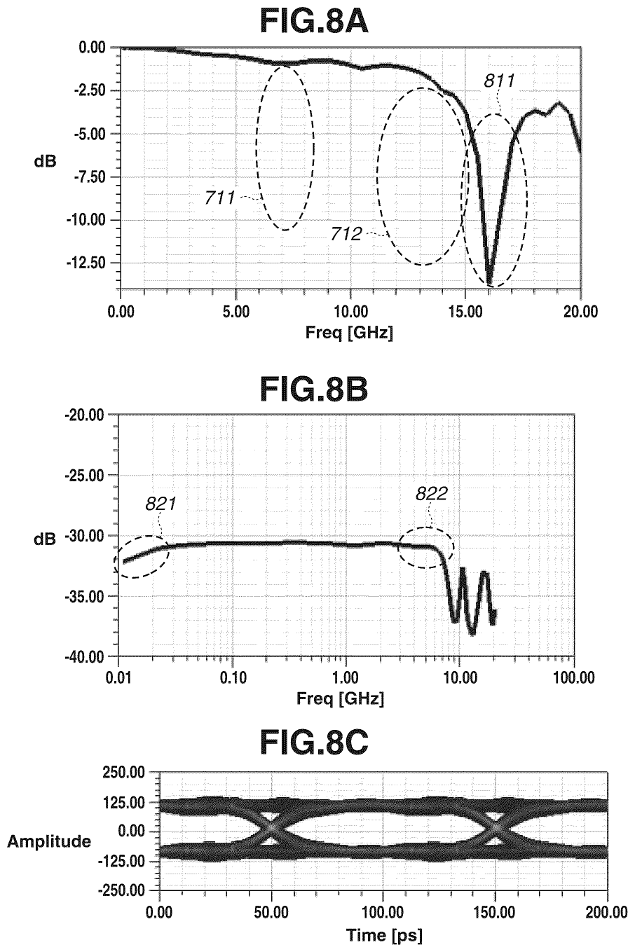

FIGS. 8A to 8C are diagrams illustrating results of analysis of the performance of the reception apparatus 200, by the electromagnetic field simulator, in the communication system 10 according to the exemplary embodiment of the present disclosure illustrated in FIG. 5. In this example, the length of the reception electrodes 210-1 to 210-10 is set to 7 mm. In addition, 10-Ω resistors as the passive elements 241 are mounted on the connection paths 240-1 and 240-3 and the connection paths 240 opposing (making differential pairs with) them. Further, 100-Ω resistors as the passive elements 241 are mounted on the connection paths 240-2 and 240-4 and the connection paths 240 opposing (making differential pairs with) them. The length of the transmission lines 130 is set to 100 mm. The input impedance of the reception circuit 230 is set to 10 kΩ.

FIG. 8A is a diagram illustrating an insertion loss (Sdd21) from a power supply part to a terminal end part in a state where the reception apparatus 200 according to the exemplary embodiment of the present disclosure illustrated in FIG. 5 is arranged in proximity to the transmission lines 130. In FIG. 8A, in the regions 711 and 712 illustrated in FIG. 7A, there is no influence of the self-resonance of the reception electrodes 210 on the transmission lines 130. On the other hand, in a region 811, there is an influence of the primary self-resonance of the reception electrodes 210-1 and 210-2 on the transmission lines 130. Even if the data transmission at the data rate of 10 Gbps is assumed, 16 GHz is about three times higher than 5 GHz that is the dominant frequency, and its influence on the quality of communication is considered as very slight.

FIG. 8B is a diagram illustrating an insertion loss (Sdd21) from the power supply parts of the transmission lines 130 to an input part of the reception circuit 230 according to the exemplary embodiment of the present disclosure illustrated in FIG. 5. In FIG. 8B, attention will be focused on the received signal intensity in a low-frequency band in a region 821. The received signal intensity in a low-frequency band in the region 821 starts to gradually decrease around 20 MHz and drops by about −1.5 dB at 10 MHz, with respect to the received signal intensity around 1 GHz (the approximate average of received signal intensity). In FIG. 8B, a region 822 indicates the received signal intensity around the dominant frequency of 5 GHz (the received signal intensity in a high-frequency band) at the assumed data rate of 10 Gbps. The received signal intensity around the region 822 hardly changes with respect to the received signal intensity around 1 GHz.

FIG. 8C is a diagram illustrating a signal eye pattern observed at the input part of the reception circuit 230 according to the exemplary embodiment of the present disclosure illustrated in FIG. 5. The data rate of signal transmission in the transmission lines 130 is set to 10 Gbps. In this case, the eye opening rate is 90.2%.

Hereinafter, a discussion will be made on the results of electromagnetic field simulation of the performance of the reception apparatus 1200 according to the comparative example illustrated in FIGS. 7A to 7C and the results of electromagnetic field simulation of the performance of the reception apparatus 200 according to the exemplary embodiment of the present disclosure illustrated in FIGS. 8A to 8C. From the results illustrated in FIGS. 7A to 7C and 8A to 8C, it has been confirmed that the reception apparatus 200 according to the exemplary embodiment of the present disclosure achieves the effect of increasing “[3] the received signal intensity in a low-frequency band” by 3.5 dB by extending the total physical length of the reception electrodes 210 up to about 7 (mm)×5=about 35 (mm). Further, it has been confirmed from the results illustrated in FIGS. 8A to 8C that the reception apparatus 200 according to the exemplary embodiment of the present disclosure exerts no influence on the transmission lines 130 in bands of the dominant frequency of 5 GHz and less at the assumed data rate of 10 Gbps. In addition, it has been confirmed from the results illustrated in FIGS. 8A to 8C that the reception apparatus 200 according to the exemplary embodiment of the present disclosure indicates no decrease in the received signal intensity around the dominant frequency of 5 GHZ (the received signal intensity in a high-frequency band). As a result of the above-described improvements in the performance of the reception apparatus 200 according to the exemplary embodiment, it has been confirmed that setting the data rate of signal transmission in the transmission lines 130 to 10 Gbps increases the opening rate of an eye pattern of a signal observed at the input part of the reception circuit 230 by about 7.0%.

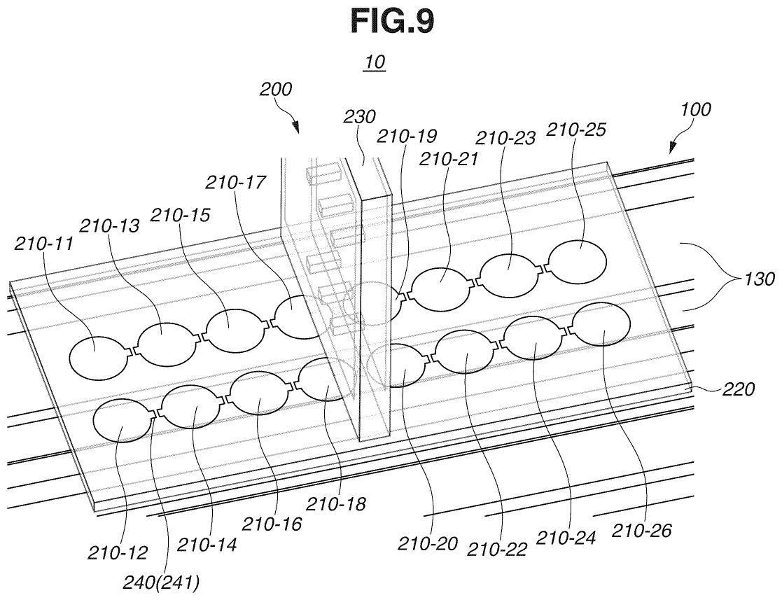

FIG. 9 is a diagram illustrating a second example of the overview of the configuration of the communication system 10 according to the exemplary embodiment of the present disclosure. In FIG. 9, components similar to those illustrated in FIGS. 1 and 5 are indicated by the same reference signs, and detailed descriptions thereof will be omitted.

In the communication system 10 of the first example according to the exemplary embodiment of the present disclosure illustrated in FIG. 5, the reception electrodes 210-1 to 210-10 of the reception apparatus 200 each have a rectangular shape. In this respect, the effects achieved by the reception apparatus 200 according to the exemplary embodiment of the present disclosure are not impaired by the shape of the reception electrodes 210. Specifically, in the communication system 10 of the second example according to the exemplary embodiment of the present disclosure illustrated in FIG. 9, a plurality of reception electrodes 210-11 to 210-26 of different shapes is arranged. In addition, in the communication system 10 of the second example according to the exemplary embodiment of the present disclosure illustrated in FIG. 9, the adjacent reception electrodes 210 of different shapes are connected via a connection path 240 including at least one passive element 241.

The effects of the reception apparatus 200 according to the exemplary embodiment of the present disclosure can be achieved regardless of the mode of the transmission lines 130 opposing thereto. In the exemplary embodiment of the present disclosure, two differential lines are assumed to be arranged as the transmission lines 130 of the reception apparatus 200. Alternatively, in the present disclosure, one transmission line may be applied. In the present disclosure, the transmission lines 130 of the transmission apparatus 100 include an electrode group excited by data signals.

The reception apparatus 200 according to the exemplary embodiment of the present disclosure described above includes the plurality of reception electrodes 210 arranged at positions opposing one transmission line 130 of the transmission apparatus 100, and the connection path 240 connecting the plurality of reception electrodes 210. In addition, in the reception apparatus 200 according to the exemplary embodiment of the present disclosure, the connection path 240 includes at least one passive element 241 in series between the plurality of reception electrodes 210.

With this configuration, since at least one passive element 241 is included in the connection path 240 connecting the plurality of reception electrodes 210, the plurality of reception electrodes 210 can be operated as electrically independent reception electrodes 210. This improves characteristics of received signals received by the reception apparatus 200 as compared to a case where the passive element 241 is not arranged on the connection path 240.

In the exemplary embodiment of the present disclosure illustrated in FIGS. 5 and 9, the plurality of reception electrodes 210 and the plurality of connection paths 240 are respectively arranged at positions opposing the two differential lines applied as the transmission lines 130. However, the present disclosure is not limited to this mode. The present disclosure also includes a mode in which the plurality of reception electrodes 210 and the plurality of connection paths 240 are arranged at positions opposing at least one of the two differential lines applied as the transmission lines 130.

In the reception apparatus 200 of the first example according to the exemplary embodiment of the present disclosure illustrated in FIG. 5, as the plurality of reception electrodes 210 arranged at positions opposing one transmission line 130, five reception electrodes 210 are arranged. In the reception apparatus 200 of the second example according to the exemplary embodiment of the present disclosure illustrated in FIG. 9, as the plurality of reception electrodes 210 arranged at positions opposing one transmission line 130, eight reception electrodes 210 are arranged. In this respect, in consideration of the effect of increasing the total physical length of the reception electrodes 210 described above with reference to FIGS. 8A to 8C, as the plurality of reception electrodes 210 arranged at positions opposing one transmission line 130, arranging three or more reception electrodes 210 is preferred.

The exemplary embodiment of the present disclosure described above is mere an example of embodiment of the present disclosure, and the technical scope of the present disclosure should not be construed in a limited manner due to the exemplary embodiment. In other words, the present disclosure can be carried out in various forms without departing from the technical concept or major features thereof.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-115400, filed Jul. 13, 2023, which is hereby incorporated by reference herein in its entirety.

What is claimed is:

1. A reception apparatus comprising:
a plurality of reception electrodes arranged at positions opposing one transmission line of a transmission apparatus; and
a connection path configured to connect the plurality of reception electrodes,
wherein the connection path includes at least one passive element between the reception electrodes.

2. The reception apparatus according to claim 1,
wherein the transmission apparatus includes a plurality of transmission lines, and
wherein the plurality of reception electrodes and the connection path are arranged at positions opposing at least one transmission line of the plurality of transmission lines.

3. The reception apparatus according to claim 2, wherein the plurality of reception electrodes and the connection path are arranged at positions opposing each transmission line of the plurality of transmission lines.

4. The reception apparatus according to claim 1, wherein the plurality of reception electrodes arranged at positions opposing the one transmission line is three or more reception electrodes.

5. The reception apparatus according to claim 1, wherein the plurality of reception electrodes is arranged on a dielectric substrate.

6. The reception apparatus according to claim 5, wherein the connection path connects the plurality of reception electrodes via a through-hole via formed in the dielectric substrate.

7. The reception apparatus according to claim 1, wherein the at least one passive element includes a resistor.

8. The reception apparatus according to claim 1, wherein the at least one passive element includes an inductor.

9. The reception apparatus according to claim 1, wherein the at least one passive element includes a ferrite bead.

10. A communication system comprising:
the reception apparatus according to claim 1; and
the transmission apparatus.
